(19) United States
(12) Patent Application Publication
(10) Pub. No.: US 2003/0171995 A1
(43) Pub. Date: Sep. 11, 2003

(54) Method and system for transacting and negotiating business over a communication network using an infomediary computer

(75) Inventors: Anthony J. Dezonno, Bloomingdale, IL (US); Roger A. Sumner, Batavia, IL (US); Mark J. Power, Carol Stream, IL (US)

Correspondence Address: Welsh & Katz, Ltd., Eric D. Cohen, 22nd Floor, 120 South Riverside Plaza, Chicago, IL, 60606, US

(73) Assignee: Rockwell Electronic Commerce Technologies, L.L.C., Wood Dale, IL (US)

(21) Appl. No.: 10/093,304

(22) Filed: Mar. 7, 2002

(51) Int. Cl. G06F 17/60

(52) U.S. Cl. 705/26

(57) ABSTRACT

An infomediary transaction system to facilitate the buying and selling of goods or services between buyers and sellers includes a buyer transaction processor configured to obtain buyer transaction preferences and develop a transaction request. An infomediary server is configured to remotely communicate with the buyer transaction processor, and is also configured to solicit and receive transaction offers from sellers of the goods or services. A negotiation proxy is configured to transmit the transaction request to the infomediary server, and is further configured to iteratively negotiate transactions with the infomediary computer in accordance with the transaction request. The buyer transaction handler receives the transaction offers from the infomediary computer and presents selected transaction offers to the buyer to achieve buyer-driven transactions.

### FIELD OF THE INVENTION

The present invention relates generally to a method and system for transacting business, and more specifically to an infomediary transaction system for exchanging information between buyers and sellers over a communication network to achieve business transactions favorable to buyers.

### BACKGROUND

Due to the advancement of communication technologies, such as the Internet and the world wide web (WWW), commercial transactions dealing with goods and services have changed greatly. The advantages of commercial transaction using the Internet are manifold. First, many middlemen between buyers and sellers are eliminated. Second, because buyers can purchase or reserve goods and services through the communication network, the need for physical stores to display goods and invite customers is reduced.

On-line auctions, such as the type provided by E-Bay, are well known. A typical auction proceeds in the following way: First, an intermediary between the seller and the buyer announces the start of the auction with a relatively low price. The buyer offers a price higher than that suggested by the intermediary. Another buyer then offers a price still higher than the predecessor's price. This procedure increases the price continuously, while the number of buyers gradually decreases. The intermediary then sells the goods to the highest bidder. Alternatively, a seller may announce the price to invite buyers bid on an item to be sold without involving an intermediary. In a typical auction, there is one seller and a plurality of potential buyers. Accordingly, the seller has the power to determine the final deal.

Another known method is referred to as a “reverse auction” method, which is disclosed in U.S. Pat. No. 5,794,207. The patent discloses an auction procedure that is “inverse” to the traditional style of auction between sellers and buyers for goods or services. In such a reverse auction the buyer has the power to determine the price. In this method, it is presumed that a plurality of sellers exist for one buyer. Thus, the buyer announces a price he or she is willing to pay. An intermediary or service provider posts the desired price to the plurality of sellers via a communication network. Each seller offers a price determined by considering the buyer's desired purchase price. The intermediary informs the buyer of the prices offered, and the buyer typically buys at the lowest selling price, all other things being equal. In the reverse auction, by using the communication network, the service provider acts as the intermediary. The transaction is established when the seller agrees to sell or the intermediary selects a seller from the plurality of sellers. By prompting the buyer to enter a credit card number or its equivalent, the transaction can be completed.

The reverse auction method, including those offered by “PRICELINE.COM” however, have significant drawbacks. In this method, the buyer is obligated to accept the seller's offer if the seller meets the buyer's terms, which is typically based on price. Thus, if the seller's response matches the condition, i.e., the price desired by the buyer, the transaction is automatically completed. The buyer typically cannot compare the conditions proposed by the plurality of sellers or selected seller that best matches the buyer's preference. Hence, this method does not allow room for negotiation and does not efficiently promote free competition for goods and services despite the availability of a seller that is willing to beat the price offered by a predecessor seller.

Additionally, on-line auctions and on-line reverse auctions require that the potential buyer devote a fair amount of time to the selection process. The buyer must log onto the Internet or other communication network and participate in the auction method offered by the selected service provider. He or she must browse or search for the goods desired and must then interact with the system according to the rules and procedures instituted by the service provider. Although this may be more convenient than traveling to a store to purchase an item, and does provide some additional flexibility, it is still inefficient and burdensome to the user.

It is desirable to have a system that automatically searches for a desired item to buy and iteratively negotiates the best possible price without user intervention.

### SUMMARY

The disadvantages of present on-line transaction systems are substantially overcome with the present invention by providing a novel method and system for transacting and negotiating business over a communication network using an infomediary.

More specifically, one embodiment of the present invention includes an infomediary transaction system to facilitate the buying and selling of goods or services between buyers and sellers. The infomediary transaction system includes a buyer transaction processor configured to obtain buyer transaction preferences and develop a transaction request. An infomediary server is configured to remotely communicate with the buyer transaction processor, and is also configured to solicit and receive transaction offers from sellers of the goods or services. A negotiation proxy is configured to transmit the transaction request to the infomediary server, and is further configured to iteratively negotiate transactions with the intermediary server in accordance with the transaction request. The buyer transaction handler receives the transaction offers from the infomediary server and presents selected transaction offers to the buyer to achieve buyer-driven transactions.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a high-level block diagram of a specific embodiment of the infomediary transaction system according to the present invention;

FIG. 2 is a data flow block diagram of a specific embodiment of a transaction request; and

FIG. 3 is a textual representation of a specific embodiment of a buyer profile.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

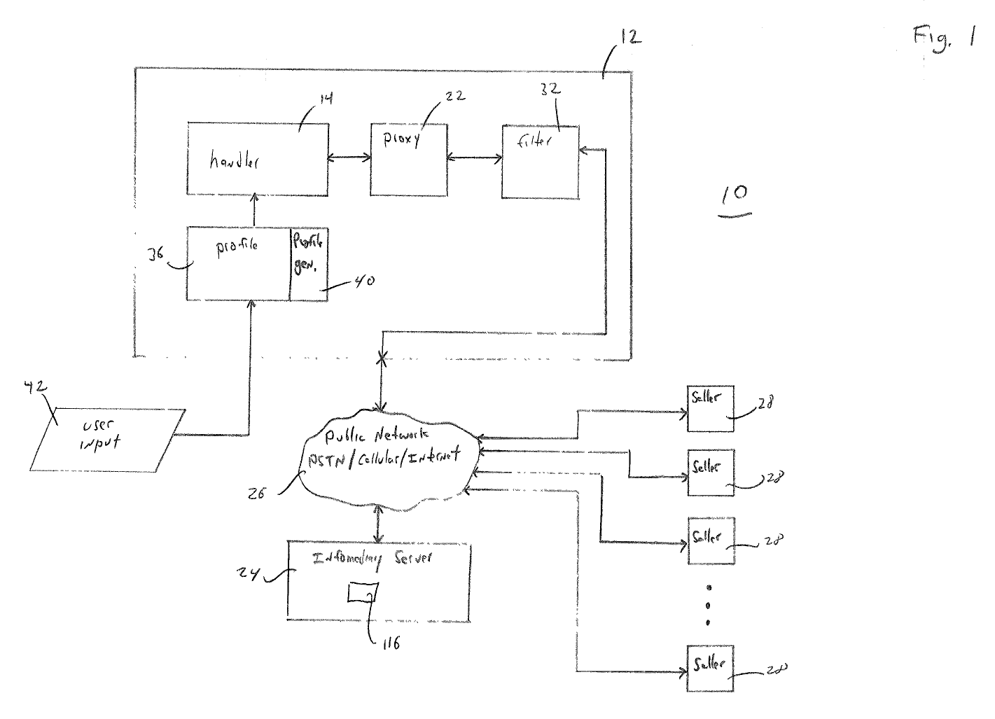

Referring now to FIG. 1, a high level block diagram of a specific embodiment of an infomediary transaction system 10 is shown generally. The system 10 facilitates the buying and selling of goods or services between the buyers and the sellers. Note that the phrase “goods and services” and “goods or services” are used interchangeable and is not meant to indicate any particular Boolean combination. Accordingly, the infomediary transaction system 10 is configured to assist in the procurement of goods, services, goods and services, and goods and/or services, or any combination thereof.

Briefly, in operation, a buyer or user in the example embodiment of FIG. 1 accesses a buyer computer 12 to facilitate a transaction or purchase, which computer may be, for example, the buyer's personal computer. In one specific embodiment, the buyer computer 12 preferably includes a buyer transaction handler 14 operatively coupled to the buyer computer. The buyer transaction handler 14 may “calculate” that the buyer wishes to make a possible purchase, or the buyer may direct the buyer transaction handler to attempt to make a specified purchase. This “calculation” process may be, for example, a rule-based process that develops a rule-based inference based on a set of predetermined conditions for the terms of a purchase, which terms may be specified by the user. Such terms may include, for example, maximum price, date of delivery, mode of delivery, mode of payment, and the like. Alternately, the “calculation” process may be a “fuzzy logic” type of process, as is known in the art.

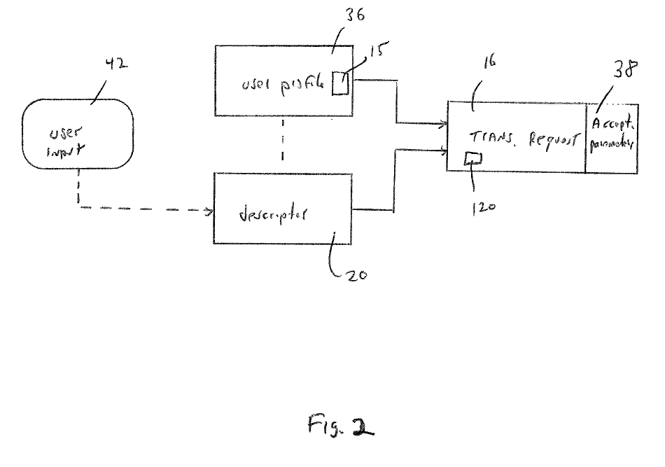

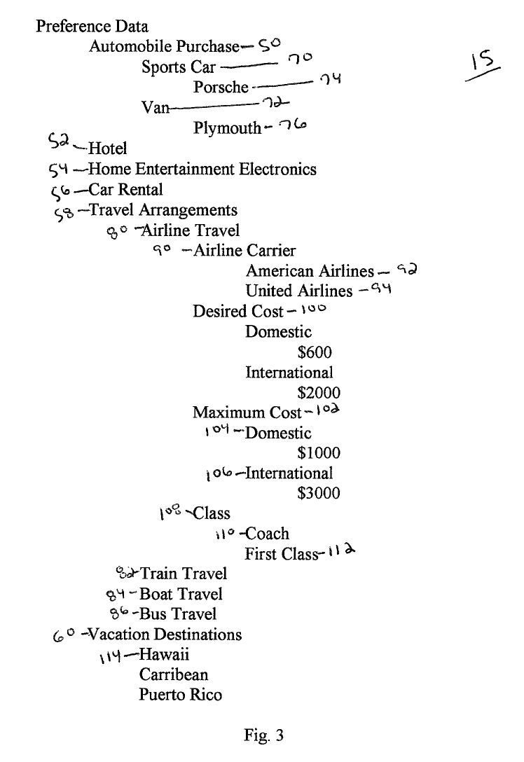

In the illustrated embodiment of FIGS. 1 and 2, the buyer transaction handler 14 is configured to obtain buyer transaction preferences 15 (e.g. FIG. 3) and develop or create a transaction request 16, where the transaction request may include a transaction descriptor 20 that identifies the goods or services desired by the buyer.

In one specific embodiment, the transaction request 16 may be then preferably routed to a negotiation proxy 22, which negotiation proxy may be operatively coupled to the buyer transaction handler 14. The negotiation proxy 22 is configured to transmit the transaction request 16 to an infomediary computer or server 24. In one specific embodiment, the infomediary computer 24 is remote from the buyer computer 12 and is configured to remotely communicate with the buyer computer over a communication network 26. The infomediary computer 24 is also configured to communicate with a plurality of vendor or seller computers 28 over the communication network 26.

Once the infomediary computer 24 receives the transaction request 16 from the buyer computer 12, it may pass the transaction request to selected seller computers 28. In response to the transaction request 16, one or more of the seller computers 28 may respond with transaction offers, which represent the goods or services that the sellers are willing to sell to the buyer, and the terms of the proposed offer. Once the infomediary computer 24 receives the transaction offers from the seller computers 28, it may pass the transaction offers back to the negotiation proxy 22 for evaluation. Essentially, the negotiation proxy 22 handles the dialog or transactions between the buyer transaction handler 14 and the infomediary computer 24, and is configured to iteratively negotiate transactions with the infomediary computer in accordance with the transaction request 16.

Note that in one specific embodiment, a message filter 32 may be operatively coupled between the negotiation proxy 22 and the infomediary computer 24. Thus, in this specific embodiment, the negotiation proxy 22 may not directly communicate with the infomediary computer 24, but rather, may indirectly communicate with the infomediary computer through the message filter 32. The message filter 32 may be configured to selectively filter the transaction offers received from the infomediary computer 24. The message filter 32 may reject or filter unwanted or unsolicited communications, such as unwanted or unsolicited transaction offers, including what is referred to as “spam.” However, once a transaction offer is passed through the message filter 32, and the negotiation proxy 22 receives the transaction offer, the transaction offer may be routed back to the buyer transaction handler 14 for presentation to the buyer to achieve fulfillment of buyer-driven transactions.

Turning now to certain components of the illustrated embodiment of the infomediary transaction system 10, the buyer computer 12 or server is preferably included, which may, for example, be a personal computer. Preferably, the buyer computer 12 is an IBM brand compatible personal computer, having for example, a Pentium® microprocessor running under DOS, Windows®, or Windows NT® 4.0 as its operating system 10. The buyer computer 12, however, may be any computer, processor, central processing unit (CPU), microprocessor, RISC (reduced instruction set computer), mainframe computer, work station, single chip computer, distributed processor, server, controller, micro-controller, remote computer, internet computer, web computer, personal digital assistant, and the like. The buyer computer 12 includes various components that are known in the art and which need not be shown, such as RAM, ROM, processor, hard disc storage, input/output devices, display screen, keyboard, mouse, modem, network interface, and the like.

Preferably, all of the processing or “logical” components of the buyer computer 12, such as the buyer transaction handler 14, the negotiation proxy 22, and the message filter 32 reside within the buyer computer as software modules. Because the buyer computer 12 may comprise hardware and/or software, such processing components may also, for example, be in the form of either hardware or software (or a combination of both), or may be separate components, distributed components, or may be integrated at a single location or in a single cabinet. Accordingly, such components may be expandable or modular such that added capability may be added when needed.

Preferably, in the illustrated embodiment of FIG. 1, the buyer transaction handler 14 is the user's or buyer's interface in the infomediary transaction system 10. As described above, the buyer transaction handler 14 generates a transaction request 16, which represents what the buyer wants and the terms to which he or she is agreeable. The buyer transaction handler 14 may create the transaction request 16 in conjunction with a buyer profile 36 and data from the transaction descriptor 20.

Referring now to FIGS. 2-3, an example of buyer preference data 15 in the buyer profile 36 is shown in FIG. 3, while an example of the data components of the transaction request 16 is shown in FIG. 2. FIG. 2 illustrates an embodiment in which the buyer transaction handler 14 creates the transaction request 16 using a combination of data from the buyer profile 36 along with data from the transaction descriptor 20. The buyer profile 36 may contain the buyer preferences 15 while the transaction descriptor 20 may represent goods or services desired to be purchased by the buyer. Additionally, the transaction request 16 may contain a plurality of acceptance parameters 38, which may, for example be culled or derived from the buyer profile 36 and the transaction descriptor 20.

Preferably, the buyer profile 36 is generated as part of a start-up or initialization of the infomediary transaction system 10. A profile generator 40 (FIG. 1) is preferably part of the buyer profile 36 software block, buy may be a separate software module or may be distributed and remote from the buyer computer 12. In one specific embodiment, a questionnaire or form may be presented to the buyer or user by the profile generator (FIG. 1) where the buyer may supply the answer to various questions or may check certain dialog boxes in the questionnaire or form, as is shown by user input 42. The buyer may be asked to fill in certain information regarding various goods or services that may be desired, or which may have been previously purchased, minimum and maximum or fair price of various items, the type of goods the buyer currently possesses, such as house, car, and the like, and any other suitable information.

Any number of sub-categories and levels thereof may be included in the buyer profile 36 sufficient to provide a meaningful indication of the buyer's buying preferences. The number of divisions, levels and/or categories is essentially unlimited in size and level of detail. Practical and ergonomic considerations, however, such as the buyer's willingness to enter such data into the questionnaire or form may place a practical upper limit on the complexity and completeness of the data contained in the buyer profile 36. The buyer profile 36 may be a computer file or a database file resident on the hard disc of the buyer computer 12, or may be remotely accessible to the buyer computer. Any suitable structure may be used to contain the buyer profile 36, as is known in the art, for example, a tree structure, which may be incorporated into a relational database or a flat database, and the like.

Referring now to FIG. 3, one specific example of the buyer profile data 15 in the buyer profile 36 is shown. The buyer profile 36 may contain various information about the buyer's preferences. For example, as shown in FIG. 3, the buyer profile data 15 may be divided into multiple categories, such as, for example, Automobile Purchase 50, Hotel 52, Home Entertainment Electronics 54, Car Rental 56, Travel Arrangements 58, Vacation Destinations 60, and the like. Of course, as stated above, there is no limit on the type or number of entries in the buyer profile 36. In the illustrated embodiment of FIG. 3, the category of Automobile Purchase 50 may be further divided into the sub-categories of Sport Car 70 and Van 72. The sub-category of Sport Car 70 includes the preference of a Porsche 74, while the sub-category of Van 72 may include the preference of a Plymouth 76. This means that if the buyer is interested in purchasing an automobile, then if a sports car is desired, the buyer prefers to buy the Porsche 74. Conversely, if the buyer is interested in purchasing an automobile, and if a Van 72 is desired, then the buyer prefers to buy the Plymouth Van 76. For purposes of clarity, only the categories of Automobile Purchase 50, Travel Arrangements 58, and Vacation Destinations 60 are shown with further subdivisions.

As another example, the entry labeled as Travel Arrangement 58 in the buyer profile 36 of FIG. 3 may be further divided into sub-categories, such as Airline Travel 80, Train Travel 82, Boat Travel 84 and Bus Travel 86. The Airline Travel 80 sub-category may be further divided into Airline Carrier 90 wherein the Airline Carrier 90 sub-category may, for example, list American Airlines 92 as the first airline of choice and United Airlines 94 as the second airline of choice. According to the above-described profile example, the buyer would prefer to fly on American Airlines 92 whenever possible. Additional classifications are also contemplated, such as Desired Cost 100 for tickets, and Maximum Cost 102 that the buyer would be willing to pay for an airline ticket, which may be further dependent upon the geographical destination, such as shown in the entries labeled Domestic 104 and International 106. Thus, in the illustrated embodiment, the buyer would prefer to pay $600 for a Domestic airline ticket, but would be willing to pay a maximum of $1,000. Other preferences within the sub-category of Airline Travel 80 may include Class 108, for which the preference of Coach 110 is shown.

In the above-described example illustrating one embodiment of the buyer profile data 15, the buyer may specifically inform or direct the buyer transaction handler 14 that the buyer desires to purchase a specific item or plurality of items. This is referred to as a “buyer-specified solicitation” because as the name implies, the buyer specifies what is desired. For example, the buyer may notify the buyer transaction handler 14 that the buyer wishes to travel to Los Angeles by airplane. Accordingly, the transaction request 16 created by the buyer transaction handler 14 would contain the transaction descriptor 20 specified by the buyer identifying the desired purchase of an airline ticket.

Additionally, the transaction request 16 may include a plurality of preference parameters or data obtained from the buyer profile 36. For purposes of clarity, when such buyer preferences from the buyer profile 36 are included in the transaction request 16, they will be referred to as the acceptance parameters 38, because they determine if a potential transaction is acceptable to the buyer. With respect to the above example using the buyer profile 36 of FIG. 3, the transaction request 16 may indicate that airline ticket sought is an American Airline ticket, where the ticket must be a Coach ticket for $600, as this is the desired price. Accordingly, the acceptance parameters 38 associated with the transaction request 16 may specify American Airline, Coach 110 ticket, and desired price of $600, which data was obtained directly from the buyer profile 36.

There may also be other acceptance parameters 38 not specifically enumerated. Additionally, some of the acceptance parameters 38 may be weighted differently than other acceptance parameters. Such weighting factors may also be resident in the buyer profile 36. For example, the price may be very important to the buyer and may not susceptible to change, whereas the buyer may not place great importance in the Airline Carrier 90 selection. Accordingly, the buyer may accept offers for tickets from other airlines if the price is met. As described above, some or all of the acceptance parameters 38 may be directly obtained or may be derived from the various entries in the buyer profile 36.

Further, some of the acceptance parameters 38 may be applicable to certain types of transaction descriptors 20, while others are not. By way of further example, additional acceptance parameters (and/or buyer profile 36 entries) may include Latest Acceptable Delivery Date of Goods or Services. This type of acceptance parameter 38 may be involved when, for example, the buyer wishes to purchase furniture. In this situation, the acceptance parameters may include a date indicating that delivery must be taken within three months, else the buyer is not interested. Of course, as described above, such parameters may be directly specified by the buyer, or may be already included in the buyer profile 36, depending upon how comprehensive the buyer profile 36 is.

The above-described examples are most easily understood in the context of the buyer-specified solicitation, defined above, in which for example, the buyer indicated to the buyer transaction handler 14 that he or she desired to travel to Los Angeles via airplane on a particular date. Accordingly, as shown in the above example, by accessing the buyer profile 36 in conjunction with the transaction descriptor 20, the buyer transaction handler 14 may generate a transaction request 16 to attempt to solicit offers for Coach 110 tickets to Los Angles via American Airline for $600. In the above example of a buyer-specified solicitation, the buyer directly specified the item to purchase, hence the transaction descriptor 20 was specified by the buyer.

However, the transaction request 16, and in particular the transaction descriptor 20, may be generated without direct input 42 from the buyer. In another specific embodiment, because the buyer transaction handler 14 may have complete access to the files residing on the buyer's computer 12 and may also monitor all buyer activity on the buyer computer 12, the buyer transaction handler may infer, calculate, or determine that the buyer may be interested in purchasing specific goods or services, without being specifically directed to do so by the buyer. This is referred to as a “handler-specified solicitation.” In the handler-specified solicitation mode, the buyer need not specifically identify what is desired. Essentially, the buyer transaction handler 14 makes a “calculation” or educated guess based upon a priori knowledge. As described above, such “calculation” may be made using a rule-based system or inference engine or may be based upon “fuzzy logic,” as is known in the art.

To facilitate the handler-specified solicitation mode, the buyer transaction handler 14 may be resident in the buyer computer 12 and may be continuously running in the background. As such, the buyer transaction handler 14 may be constantly monitoring the buyer's activity on the buyer computer 12 as a background activity, and hence may have access to many forms of information about the buyer and the buyer's habits. The buyer transaction handler 14 may utilize the information on the buyer's computer 12 that it had been monitoring or to which it may directly access, to create various entries in the buyer profile 36 and in the transaction descriptor 20. Further, the buyer transaction handler 14 may enter that data directly into the buyer profile 36 or the transaction descriptor 20 without intervention or direction from the buyer.

With respect to the handler-specified solicitation mode, the buyer transaction handler 14 may monitor the buyer's habits and activities in many ways. In one specific embodiment, for example, the buyer transaction handler 14 may monitor the buyer's email activity, the buyer's access of the Internet, the buyer's visits to Internet webpages, the buyer's purchases over the Internet, the buyer's usage of the buyer computer 12, the buyer's access of computer files on the buyer computer, the buyer's financial activity, and the buyer's transactions dealing with various personal financial accounts (such as banking transactions and credit card transactions), and the like.

With respect to the buyer's financial transactions, if the buyer uses a commercially available financial software program to track finances, such as, for example, QUICKEN by Intuit Corporation, the buyer transaction handler 14 may have access to the various financial transactions of the buyer, such as bank deposits, bank withdrawals, credit card purchases, investments such as stocks and bonds and the like, net assets, cash on hand, and the like. Alternately, the buyer transaction handler 14 may access the buyer's financial records over the communication network 26, such as the Internet. If the buyer transaction handler 14 is authorized with the appropriate password, commercially available communication programs may permit banking records to be accessed remotely, assuming that the buyer's banking institutions are capable of remote access. Further, if the buyer uses a commercially available scheduling or calendar program, such as OUTLOOK by Microsoft Corporation, the buyer transaction handler 14 may have access to various scheduling and time information about the buyer.

By monitoring the buyer's purchases, the buyer transaction handler 14 may determine that the buyer makes frequent expensive purchases, for example, many purchases over $2,000. Accordingly, the maximum price for certain entries in the buyer profile 36 may be higher than for a different buyer with different purchasing habits. Similarly, if the buyer transaction handler 14 “calculates” that most of the buyer's previous purchases of airline tickets were for first class tickets, the buyer transaction handler 14 may automatically enter First Class 112 under the Class 108 sub-category in the buyer profile 36 of FIG. 3.

As another example of a handler-specified solicitation, the buyer may have indicated on his or her OUTLOOK calendar that a trip to Los Angeles is planned for a particular date. Accordingly, without intervention or initiation by the buyer, the buyer transaction handler 14 may generate a transaction request 16 to obtain offers for airline tickets to Los Angeles. Using the buyer profile 36, the transaction request 16 may include a solicitation for American Airline tickets for that particular date in Coach 110 Class 108 for $600. Of course, transaction offers received in response to this transaction request 16 may or may not meet the acceptance parameters associated with the transaction request.

According to another example, the buyer transaction handler 14 may, without buyer intervention or initiation, calculate that the buyer has not taken a vacation for a predetermined period of time. Various data in the buyer computer 12 may indicate to the buyer transaction handler 14 that the buyer or user has not recently taken a vacation. For example, credit card data may indicate that no trips have been taken for a predetermined period of time. Alternately, the buyer's OUTLOOK calendar may indicate that no vacation time has been taken for a predetermined period of time. Accordingly, the buyer transaction handler 14, may “on its own,” generate a transaction request 16 directed toward obtaining airline tickets for a particular vacation destination. In such a situation, the buyer transaction handler 14 may “take it upon itself” to obtain offers for airline tickets to permit the user to fly to Hawaii 14 because Hawaii is shown as a preferred vacation destination in the buyer profile 36 of FIG. 3.

Preferably, the format in which the transaction request 16 is transmitted from the buyer computer 12 to the infomediary computer 24, and from the infomediary computer to the seller computers 28, is standardized. Preferably, the format used is XML (extensible mark-up language), as is known in the art. Preferably, the same XML format may also be used for the transaction offers transmitted from the seller computers 28 to the infomediary computer 24 and from the infomediary computer to the buyer computer 12.

As described above, the buyer computer 12 may be coupled to the infomediary computer 24 or infomediary server via the communication network 26, such as the Internet. The infomediary computer 24 may be any form of suitable processing device, such as a mainframe computer or server, or any of the processing devices described above with respect to the construction and components of the buyer computer 12. The seller computers 28 or servers may also be any form of processing device, as described above.

The connection or communication between the buyer computer 12 and the infomediary computer 24, and between the infomediary computer and the plurality of seller computers 28 is known in the art, and preferably uses standard Internet protocol. However, any suitable communication network may be used, such as an Ethernet network 90, H.323 protocol network, SIP network (Session Initiation Protocol), MGCP network (Media Gateway Control Protocol), VoFR network (Voice over Frame Relay), VoATM network (Voice over Asynchronous Transport Mode), 2G/2.5G/3G wireless network, PSTN network (Public Switched Telephone Network), T1 network and POTS or plain old telephone system 10. Essentially, any suitable communication network may be used.

The infomediary computer 24 preferably communicates with the plurality of seller computers or servers 28, also over the communication network 26, such as the Internet. The seller computers 28 represent the various sellers of goods and/or services wishing to sell their goods and/or services to buyers over the communication network 26. Note, however, that the infomediary computer 24 in the illustrated embodiment of FIG. 1 does not provide information sufficient to permit the seller computers 28 to contact or communicate directly with the buyer computer 12, nor ascertain the identity of the buyer or buyer computer. Thus, the entire transaction must be conducted through the infomediary computer 24. This protects the privacy of the buyer/buyer computer 12 while simultaneously assuring adhesion to required procedures and protocol.

The infomediary computer 24 in the embodiment of FIG. 1 inspects the transaction request 16 once received to determine which seller computers 28 to contact, which computers may be able to respond to the transaction request. The transaction descriptor 20 and some of the acceptance parameters 38 may determine which seller computers 28 are to be contacted by the infomediary computer 24. For example, if the transaction deals with airline tickets, the infomediary computer 24 will not contact seller computers 28 that only offer furniture for sale. To facilitate efficient communication with the seller computers 28, in one embodiment, the infomediary computer 24 may include a seller registration file 116 (FIG. 1) that defines at least a seller computer identity and a description of the goods and/or services for sale by that seller computer 28. Essentially, each seller computer 28 would “register” with the infomediary computer 24 and provide a description of the goods and services offered, and the appropriate electronic address for communication.

Of course, one seller computer 28 may offer for sale a plurality of different and/or unrelated products or services. For example, a seller computer 28 corresponding to a particular travel agent may sell airline tickets, hotel bookings, train tickets, and the like. As such, each of these descriptions would be included in the seller registration file 116 corresponding to that particular seller computer 28.

In some situations, the seller registration file 116 may include some additional information that is generally associated with the acceptance parameters 38 rather than with the transaction descriptor 20. For example, the seller computer 28 corresponding to an automobile dealer that sells only Rolls Royce vehicles may also include an indication that the minimum price of vehicles is $100,000. Price is usually associated with an acceptance parameter, but in this specific example, the price may be used as part of a transaction descriptor 20 for purposes of efficiency. Thus, the infomediary computer 24 need not contact the Rolls Royce seller computer for transactions in which the buyer is seeking to buy a conventional automobile under $25,000. Generally, the infomediary computer 24 forwards the transaction request 16 to seller computers 28 whose description of goods or services in the seller registration file 116 match the transaction descriptor 20 associated with the transaction request 16.

Turning now to the negotiation proxy 22, in one specific embodiment, after the buyer transaction handler 14 has generated the transaction request 16 (regardless of whether it is a buyer-specified or handler-specified solicitation), it is forwarded to the negotiation proxy 22 for processing. Note that the negotiation proxy 22 may be separate from the buyer transaction handler 14 or may be a part thereof, without departing from the scope of the invention. The negotiation proxy 22 tracks the transaction request 16, preferably with a unique transaction request identifier 120 (FIG. 2) or number, which may, for example, comprise the date, the buyer computer identification (in case the buyer uses more than one buyer computer) and a sequence number capable of determining if multiple iterations of a “base” transaction request are in progress. The transaction request identifier 120 is preferably appended to or is part of the transaction request 116, which is sent to the infomediary computer 24. Of course, the transaction request 16 may or may not be directed through the message filter 32 before it reaches the infomediary computer 24.

In the simplest form of transaction, which does not involve iterative negotiation by the negotiation proxy 22, the buyer transaction handler 14 may forward the transaction request 16 to the negotiation proxy, which may then route the transaction request through the message filter 32 for transmission to the infomediary computer 24. The infomediary computer 24 then inspects the transaction descriptor 20 associated with the transaction request 16 and contacts the selected seller computers 28 that may be able to respond to the transaction request. After the transaction request 16 has been sent to the selected seller computers 28, some, all, or none of the seller computers may respond to the infomediary computer 24 with one or more transaction offers. The infomediary computer 24 may then pass the transaction offer(s) back to the buyer computer 12.

The message filter 32 may initially receive the transaction offers and may route the transaction offers to the negotiation proxy 22, assuming of course, that the transaction offer is authentic and that it corresponds to transaction request 16. To authenticate the transaction offer, the message filter 32 may, for example, require that the transaction offer include the transaction request 16 identifier previously sent to it. However, any suitable method for authenticating the communication received from the infomediary computer 24 may be used.

In the above example of a non-iterative negotiation involving airline tickets, the parameters associated with the transaction offer matches the acceptance parameters 38 of the transaction request 16. This means that the seller offered to sell the buyer coach tickets to Los Angeles on the selected date for $600. In other words, the buyer's acceptance parameters 38 were met by the seller's transaction offer. The buyer would then have an opportunity to accept the offer, pay for the goods, and complete the transaction. In one specific embodiment, fulfillment of the transaction occurs when the buyer tenders payment for the ticket in the form of a credit card number, which may be sent from the negotiation proxy 22 through the message filter 32 to the infomediary computer 24.

However, a particular transaction offer may be close, but may not exactly match all of the acceptance parameters specified by the buyer. In one illustrated example, perhaps the transaction offer was slightly higher in price than the buyer's desired cost of $600. Perhaps the ticket price would have been lower if the buyer was willing to travel on an alternate day, or was willing to land at an alternate airport. In this situation, the negotiation proxy 22 may alter some of the acceptance parameters 38 and may issue and alternate transaction request 16. The alternate transaction request 16 may slightly vary some of the acceptance parameters 38 in hopes that the seller computer 28 would be able to meet the request in the next interaction. For example, the first transaction request 16 may have solicited airline ticket offers beginning at $600. However, if no sellers were willing to meet this price, the next alternate request may, for example, raise the buyer's price to $700 to determine if there are any interested sellers at this new price. In this way, the negotiation proxy 22 interactively increases the price that the buyer may be willing to pay, from the lowest price desired by the buyer to the maximum price that the buyer may be willing to pay.

As before, the alternate transaction request 16 is forwarded to the infomediary computer 24, which in turn, contacts the selected seller computers 28 to solicit transaction offers. It is contemplated that this process is iterative and may involve several alternate transaction requests 16. This may occur transparently without intervention by the buyer.

The above-described process may occur iteratively until 1) a transaction offer from the infomediary computer 24 meets the acceptance parameters, 2) a predetermined number of alternate transactions have been transmitted, but without receipt of an acceptable transaction offer, or 3) a transaction offer is presented to the buyer even though not all of the acceptance parameters have been met. In this way, the infomediary transaction system 10 can negotiate the best deal possible with the various seller computers 28 while at the same time, relieving the buyer from the tedious operational and procedural aspects of the transaction. In the most convenient form of transaction, the buyer need only approve the final transaction or fulfillment portion, as described above.

In an alternate embodiment, to achieve greater buyer-bargaining position, the infomediary computer 24 may attempt to buy “in bulk.” For example, one infomediary computer 24 preferably may receive transaction requests 16 from a plurality of buyer computers 12. Prior to directing the various transaction requests 16 to the selected seller computers 28, the infomediary computer 24 may group the transaction requests according to the corresponding transaction descriptor 20. For example, multiple buyers may wish to fly to Los Angeles on a particular day. Accordingly, the infomediary computer 24 may solicit transaction offers from the seller computers 28 based on a bulk transaction request 16 representing the solicitation of a block of airline tickets to Los Angeles. Because the same product or service is sought by a plurality of buyers, a better price or other favorable terms may be negotiated, resulting in more favorable buyer-driven transactions.

After the infomediary computer 24 transmits the transaction offers to the buyer computer 12, the buyer transaction handler 14 preferably is responsible for notifying the buyer. However, the buyer may be extremely busy and may not have sufficient time to review the transaction offer(s) or may not want to be disturbed at the time that the transaction offer arrives. Accordingly, the buyer transaction handler 14 may present selected transaction offers to the buyer, but only if the buyer is not “too” busy. To determine if the buyer is “too busy” to review a transaction offer, the buyer transaction handler 14 may calculate a time availability factor of the buyer and present the buyer with the transaction offers only if the time availability factor is greater than a predetermined value. If the time availability factor is less than the predetermined value, the buyer transaction handler 14 may elect to postpone presentation of the selected transaction to the buyer until a later time.

In that regard, the buyer transaction handler 14 may automatically compute the time availability factor by monitoring activity on the buyer computer 12. Preferably, this may be performed as a background task on the buyer computer 12. Further, the time availability factor may be automatically and periodically updated depending upon activity monitored on the buyer computer 12. As described above with respect to the monitoring of the buyer computer 12 activity to facilitate handler-specified solicitation, the buyer transaction handler 14 may also monitor other buyer computer activity to calculate and update the time availability factor. For example, the buyer transaction handler 14 may monitor the following events: the number of simultaneous open applications running on the buyer computer 12, keystroke activity on the buyer computer over a predetermined period of time, number of user sessions running on the buyer computer, and time between user sessions on the buyer computer. Each of these events, either taken alone or in combination, may provide an indication of how busy the buyer is. Clearly, if the buyer is running many software applications simultaneously and there is constant keyboard activity, it is likely that the buyer is busy with other tasks and should not be disturbed with a transaction offer. Alternatively, the buyer transaction handler 14 may calculate the time availability factor by inspecting a buyer calendar accessible to the buyer computer 12, such as the buyer's OUTLOOK calendar, which may provide an indication of the buyer's time schedule. Alternately, the buyer may specify under what circumstances he or she should be presented with transaction offers, or may elect to be periodically interrupted with the transaction offers.

Referring now to the message filter 32 (FIG. 1), as described above, the message filter may be a bi-directional filter, meaning that it may filter data or transaction offers sent from the infomediary computer 24 (“incoming” information) and/or may filter or prevent information from being sent to the infomediary computer (“outgoing” information). In one specific embodiment with respect to outgoing information, the message filter 32 may selectively prevent confidential or sensitive data from being transmitted from the buyer computer 12 over the communication network 26, in certain circumstances. Of course, to complete a transaction and purchase goods or services for sale, some amount of confidential data must be sent. For example, the buyer's credit card number must be sent to complete the transaction as long as all of the communications have been authenticated.

On the other hand, in another specific embodiment, the message filter 32 may deny requests transmitted over the communication network 26 to provide confidential information to an external computer of unknown origin. Further, the message filter 32 may intercept and delete or reject unsolicited transaction offers, even if such offers appear to be from legitimate sources. The message filter 32 may be configured to reject what has been referred to as “Spam” or junk communication. Essentially, the message filter 32 may function as a “firewall.”

Specific embodiments of a an infomediary transaction system 10 according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. An infomediary transaction system to facilitate the buying and selling of goods or services between buyers and sellers, respectively, the system comprising:
a buyer computer;
a buyer transaction handler operatively coupled to the buyer computer, the buyer transaction handler configured to obtain buyer transaction preferences and develop a transaction request, the transaction request having a transaction descriptor that identifies the goods or services desired by the buyer;
an infomediary computer configured to communicate with the buyer computer and to solicit and receive transaction offers from sellers of the goods or services;
a negotiation proxy operatively coupled to the buyer transaction handler and configured to transmit the transaction request to the infomediary computer and to iteratively negotiate transactions with the infomediary computer in accordance with the transaction request;
a message filter operatively coupled between the negotiation proxy and the infomediary computer configured to selectively filter the transaction offers received from the infomediary computer; and
wherein the buyer transaction handler receives the transaction offers through the message filter and presents selected transaction offers to the buyer to achieve fulfillment of buyer-driven transactions.

2. The system according to claim 1 wherein the buyer computer is configured to communicate with the infomediary computer over a communication network.

3. The system according to claim 1 wherein the buyer computer is configured to communicate with the infomediary computer over the Internet, and the infomediary computer is configured to communicate with the sellers of the goods or services over a communication network.

4. The system according to claim 1 wherein the buyer transaction handler is part of the buyer computer.

5. The system according to claim 1 wherein the transaction request represents goods or services desired to be purchased by the buyer, or goods or services that the buyer transaction handler determines is desired by the buyer.

6. The system according to claim 1 wherein the transaction request includes acceptance parameters associated with goods or services corresponding to the transaction request, and wherein the buyer accepts the transaction offer if the transaction offer matches the acceptance parameters associated with the transaction request.

7. The system according to claim 6 wherein the acceptance parameters are selected from the group consisting of a maximum price to be paid, time frame of usage of goods or services, specific seller of goods or services, and latest acceptable delivery date of goods or services.

8. The system according to claim 1 wherein the buyer transaction preferences are entered into a buyer profile by the buyer.

9. The system according to claim 1 wherein the buyer provides the buyer transaction preferences by responding to a plurality of queries presented to the buyer.

10. The system according to claim 1 wherein the buyer transaction preferences are automatically entered into the buyer profile without buyer intervention.

11. The system according to claim 1 wherein the buyer transaction preferences are obtained by monitoring buyer activity on the buyer computer, the monitoring performed as a task on the buyer computer.

12. The system according to claim 1 wherein the buyer transaction preferences are obtained by monitoring activity on the buyer computer, said monitoring activity selected from the group consisting of monitoring buyer email activity, monitoring buyer purchases through email activity, monitoring buyer access of the Internet, monitoring buyer visits to Internet webpages, monitoring buyer purchases over the Internet, monitoring buyer usage of the buyer computer, monitoring buyer access of computer files on the buyer computer, monitoring buyer financial activity, and monitoring buyer transactions of personal financial accounts of the buyer.

13. The system according to claim 1 wherein the buyer transaction handler is configured to inspect financial records of the buyer and to calculate at least some of the buyer transaction preferences based upon the financial records.

14. The system according to claim 1 wherein the buyer transaction handler presents the selected transactions to the buyer when a time availability factor is greater than a predetermined value, and wherein if the time availability factor is less than a predetermined value, the buyer transaction handler postpones presentation of the selected transaction to the buyer.

15. The system according to claim 14 wherein the time availability factor is automatically computed by monitoring activity on the buyer computer, and wherein the monitoring is performed as a task by the buyer computer.

16. The system according to claim 14 wherein the time availability factor is automatically and periodically updated depending upon activity monitored on the buyer computer.

17. The system according to claim 14 wherein the time availability factor is obtained by monitoring activity on the buyer computer, said monitoring activity selected from the group consisting of monitoring the number of simultaneous open applications running on the buyer computer, monitoring the keystroke activity on the buyer computer over a predetermined period of time, monitoring number of user sessions on the buyer computer, and monitoring the time between user sessions on the buyer computer.

18. The system according to claim 1 wherein the negotiation proxy associates a buyer identifier with the transaction request, and transmits the transaction request to the infomediary computer.

19. The system according to claim 6 wherein the negotiation proxy receives at least one transaction offer from the infomediary computer in response to the transaction request and determines if the at least one transaction offer meet the acceptance parameters.

20. The system according to claim 19 wherein if the transaction offers from the infomediary computer does not meet the acceptance parameters, the negotiation proxy causes at least one alternate transaction request to be sent to the informediary computer, the alternate transaction request representing a negotiation.

21. The system according to claim 19 wherein the negotiation proxy iteratively transmits a plurality of alternate transaction requests until the transaction offer from the infomediary computer meets the acceptance parameters.

22. The system according to claim 1 wherein the message filter selectively prevents confidential data from being transmitted from the buyer computer over the communication network.

23. The system according to claim 1 wherein the message filter denies requests transmitted over the communication network to provide confidential information.

24. The system according to claim 1 wherein the message filter is configured to reject unsolicited transaction offers.

25. The system according to claim 1 wherein the infomediary computer is configured to communicate with a plurality of seller computers to solicit and obtain transaction offers from the seller computers in response to the transaction request.

26. The system according to claim 1 wherein the infomediary computer includes a seller registration file that defines at least a seller identity and descriptions of goods or services sold by the seller.

27. The system according to claim 26 wherein the infomediary computer transmits the transaction request to seller computers whose description of goods or services in the seller registration file matches the transaction descriptor associated with the transaction request.

28. The system according to claim 1 wherein the infomediary computer receives transaction requests from a plurality of buyer computers and groups the transaction requests according to the transaction descriptor.

29. The system according to claim 28 wherein if the plurality of transaction requests have similar transaction descriptors, the infomediary computer solicits transaction offers from the seller computers based on bulk transaction requests.

30. An infomediary transaction system to facilitate the buying and selling of goods or services between buyers and sellers, the system comprising:
a buyer computer;
a buyer transaction handler operatively coupled to the buyer computer, the buyer transaction handler configured to obtain buyer transaction preferences and develop a transaction request, the transaction request associated with a transaction descriptor that identifies the goods or services desired by the buyer;
an infomediary computer configured to communicate with the buyer computer, the infomediary computer configured to solicit and receive transaction offers from sellers of the goods or services;
a negotiation proxy operatively coupled to the buyer transaction handler and configured to transmit the transaction request to the infomediary computer;
the negotiation proxy configured receive the transaction offers from the infomediary computer and negotiate transactions with the infomediary computer in accordance with the transaction request; and
wherein the buyer transaction handler receives the transaction offers and presents the transaction offers to the buyer to achieve buyer-driven transactions.

31. An infomediary transaction system to facilitate the buying and selling of goods or services between buyers and sellers, the system comprising:
a buyer transaction processor configured to obtain buyer transaction preferences and develop a transaction request;
an infomediary server configured to remotely communicate with the buyer transaction processor, the infomediary server configured to solicit and receive transaction offers from sellers of the goods or services;
a negotiation proxy configured to transmit the transaction request to the infomediary server, the negotiation proxy configured to iteratively negotiate transactions with the infomediary server in accordance with the transaction request; and
wherein the buyer transaction handler receives the transaction offers from the infomediary server and presents selected transaction offers to the buyer to achieve buyer-driven transactions.

32. An infomediary transaction system to facilitate the buying and selling of goods or services between buyers and sellers, the system comprising:
a buyer computer;
a buyer transaction handling means for obtaining buyer transaction preferences and for issuing a transaction request;
a transaction descriptor associated with the transaction request for identifying the goods or services desired by the buyer;
a proxy means for receiving the transaction request;
an infomediary computer configured to remotely communicate with the buyer computer, the infomediary computer configured to solicit and receive transaction offers from sellers of the goods or services;
the proxy means configured to iteratively negotiate transactions with the infomediary computer in accordance with the transaction request;
a message filter operatively coupled between the negotiation proxy and the infomediary computer, and configured to selectively filter the transaction offers received from the infomediary computer; and
wherein the buyer transaction handling means receives the transaction offers from the infomediary computer and presents selected transaction offers to the buyer to achieve buyer-driven transactions.

33. A method for buying and selling of goods or services between a buyer computer and an infomediary computer over a communication network, the method comprising:
obtaining buyer transaction preferences of a buyer;
issuing a transaction request to a negotiation proxy, the transaction request having a transaction descriptor that identifies the goods or services desired by the buyer;
transmitting the transaction request from the negotiation proxy to the infomediary computer via the communication network;
the infomediary computer soliciting transaction offers from sellers of the goods or services in response to the transaction request;
the infomediary computer receiving the transaction offers from sellers of the goods or services;
transmitting the transaction offers from the infomediary computer to the negotiation proxy;
selectively filtering the transaction offers received from the infomediary computer;
presenting the selectively filtered transaction offers to a buyer to achieve buyer-driven transaction.
